(19) United States
(12) Patent Application Publication
(10) Pub. No.: US 2026/0329690 A1
(43) Pub. Date: Oct. 22, 2026

(54) ARTIFICIAL INTELLIGENCE AGENT FOR DETECTING APPLICATION PROGRAMMING INTERFACE ERRORS AND GENERATING CORRECTIVE ACTIONS

(71) Applicant: Truist Bank, Charlotte, NC (US)

(72) Inventors: Michael Joseph Senuta, Pittsburgh, PA (US); Shane Duncan Eaton, Charlotte, NC (US); Matthew Laine Donlan, Charlotte, NC (US)

(73) Assignee: Truist Bank, Charlotte, NC (US)

(21) Appl. No.: 19/185,349

(22) Filed: Apr. 22, 2025

(51) Int. Cl. G06F 11/07; G06F 11/3668

(52) U.S. Cl. CPC G06F 11/0793; G06F 11/0766; G06F 11/3668

(57) ABSTRACT

Managing application programming interface (API) health in a computing environment using artificial intelligence (AI). A processor may identify multiple APIs and accesses related data from databases. An AI model may analyze the data to detect any errors with a specific API, after which it generates appropriate corrective actions. The AI model can also perform pre-error testing through API test calls and adapt these actions based on additional monitored data to predict future errors. The database may store data related to microservices, applications, and network elements within the environment. The system may initiate actions like resource provisioning, deploying API instances, modifying API execution, or rerouting network traffic. Additionally, indicators of errors and corrective actions may be visualized through a graphical user interface.

### BACKGROUND

Application Programming Interfaces (APIs) are tools that enable software programs to communicate with each other. APIs provide a set of defined methods and protocols that allow developers to access the functionalities of an application or service without needing direct access to its underlying codebase. APIs serve as bridges between different software applications, enabling interoperability and facilitating the integration of various services, such as a social media application accessing device camera functionality or a weather app pulling current data from a remote server.

One of challenges in computing environments, particularly when working with APIs, is error detection and correction. Conventional solutions are unable to accurately identify the source of errors, particularly when different applications are dependent on any number of different APIs.

### BRIEF SUMMARY

In various embodiments, a method comprises a processor determining multiple application programming interfaces (APIs) within a computing environment. The processor accesses one or more databases that contain data related to these APIs and the computing environment. An error associated with the first API is identified using an artificial intelligence (AI) model executing on the processor and based on the data from the databases. The AI model then generates a corrective action based on this error, and the processor initiates the performance of this corrective action.

In some embodiments, a non-transitory computer-readable storage medium contains instructions that, when executed by a processor, cause the processor to: determine multiple APIs in a computing environment, access relevant databases, utilize an AI model to identify an error with a first API, generate a corrective action, and initiate the performance of the corrective action.

An apparatus includes a processor and a memory storing instructions. When these instructions are executed by the processor, they cause the processor to determine several APIs, access associated databases, use an AI model to detect an error with a first API, generating a corrective action, and initiate performance of the corrective action.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates a logic flow 600 in accordance with one embodiment.

FIG. 7A is a diagram of a feedforward network, according to at least one embodiment, utilized in machine learning.

FIG. 7B is a diagram of a convolutional neural network, according to at least one embodiment, utilized in machine learning.

FIG. 7C is a diagram of a portion of the convolutional neural network of FIG. 7B, according to at least one embodiment, illustrating assigned weights at connections or neurons.

FIG. 8 is a diagram representing an exemplary weighted sum computation in a node in an artificial neural network.

FIG. 9 is a diagram of a Recurrent Neural Network (RNN), according to at least one embodiment, utilized in machine learning.

FIG. 10 is a schematic logic diagram of an artificial intelligence program including a front-end and a back-end algorithm.

FIG. 11 is a flow chart representing a method, according to at least one embodiment, of model development and deployment by machine learning.

FIG. 12 illustrates a computing system 1200 in accordance with one embodiment.

### DETAILED DESCRIPTION

Embodiments disclosed herein provide techniques to proactively manage and maintain the health of computing environments and any component thereof, such as application programming interfaces (APIs), microservices, databases, applications, networks, hardware resources (e.g., computing systems and/or any component thereof), or any other type of software resources.

Generally, embodiments disclosed herein provide robust mechanisms for monitoring the health and availability of resources in computing environments. Generally, the monitoring may include generating and storing data describing the computing environment over time. In some embodiments, the data gathered via the monitoring is stored in one or more databases, supported by microservices and internal visualizations for visibility. The monitoring may generate data describing any number and type of attributes of the monitored components. For example, for APIs, the attributes may include traffic volume, response times, responses, and/or error rates

The monitoring may enable auditing, tracking, and reporting of health checks performed against internal systems, including APIs exposed to consumers. In some embodiments, auditing service availability, verifying uptime and downtime, and creating visualizations for different user roles, such as business users, support users, and developers, may be provided. Doing so may offer different levels of visibility into system health and performance. For example, developers may be provided with interfaces for debugging and/or performance monitoring, e.g., to identify and/or correct errors.

In some embodiments, artificial intelligence (AI) may be used to predict and prevent errors through automated resource scaling and intelligence, including in high-volume payment environments. In some embodiments, errors may be predicted based on historical patterns and real-time data. Similarly, AI models may be enriched with continuous learning capabilities, e.g., to retrain AI models based on new data, trends, patterns, etc. For example, in some embodiments, predetermined rules and/or criteria may be used to assess the health and performance of system components. These rules may include thresholds for response times, error rates, and/or traffic patterns, etc., which may be used to identify anomalies and/or trigger alerts. Over time, AI models may be used to modify these rules and/or define new rules. For example, by analyzing historical data and learning from patterns, the AI models may adjust the criteria to improve accuracy, reduce false positives, and enhance the ability to predict and prevent issues proactively. This continuous learning process ensures that the monitoring system evolves and adapts to changing conditions and requirements.

In some embodiments, multi-form and multi-directional visibility and monitoring may be provided. Generally, different forms of software may be supported by embodiments disclosed herein. For example, the software may be provided via one or more of APIs, chatbots, visualizations, mobile applications, voice-response assistants, artificial intelligence assistants, etc. Furthermore, the multi-directional support enables any entity to inquire about the health of another entity, respond to an inquiry received from another entity, and/or inform another entity about the health of that entity. For example, a first entity may inform a second entity “your transaction processing speed is below a critical threshold.” Similarly, the second entity may ask the first entity “is my transaction processing speed at acceptable levels?”

In some embodiments, a deterministic response may be generated based on a non-deterministic and/or generic question. For example, a natural language request such as “is my real-time service available and healthy?” However, there may be dozens or more of different variables (e.g., underlying systems) involved in answering the question that the requestor doesn't know about. Therefore, embodiments disclosed herein may infer from the question based on metadata (which may include curated metadata and/or inferred metadata), what other questions should be asked and answered in order to answer the original question.

For example, to answer the previous question of “is my real-time service available and healthy?”, embodiments disclosed herein may poll multiple applications, multiple different databases, multiple different network zones, and multiple network devices. Based on the polling, embodiments disclosed herein may generate more questions. For example, embodiments disclosed herein may determine that one of the network zones is down. Therefore, embodiments disclosed herein may identify, as a corrective action, a question of whether re-routing network traffic will allow the traffic to reach its ultimate destination. Embodiments disclosed herein may then determine whether re-routing the traffic according to different network reconfigurations will allow the traffic to reach its destination (e.g., without traversing the network zone that is down). Embodiments disclosed herein may then select the network reconfiguration that allows the traffic to reach its destination and reconfigure the network according to the selected network configuration. In some embodiments, the different questions and/or steps in the processing flow may be part of a decision tree that may be configured and/or learned through the actual execution over time.

In some embodiments, self-healing capabilities are enabled to address challenges automatically. By integrating business intelligence capabilities, embodiments disclosed herein may provide insights into revenue and return on investment and facilitating proactive monitoring and orchestration of resources.

When errors are predicted and/or detected, any number and type of corrective actions may be automatically performed to prevent and/or correct the errors. For example, in some embodiments, automated resource scaling may be used, e.g., to adjust computing resources proactively to prevent failures, respond to failures, etc. As another example, new cloud resources may be deployed, application instances may be instantiated, network traffic may be rerouted, etc.

Generally, embodiments disclosed herein provide a framework of features that work together to create a robust, intelligent system for monitoring, predicting, and addressing performance issues, enhancing overall system health and efficiency. Furthermore, embodiments disclosed herein may reduce false positives relative to conventional solutions. In some embodiments, AI may be used to proactively predict future errors, generate preemptive actions to prevent the predicted errors from occurring, and initiate performance of the preemptive actions to prevent the predicted errors from occurring. By predicting errors that may occur in computing systems and preventing their occurrence, embodiments disclosed herein improve the performance of the computing system by ensuring uptime and availability. Embodiments are not limited in these contexts.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

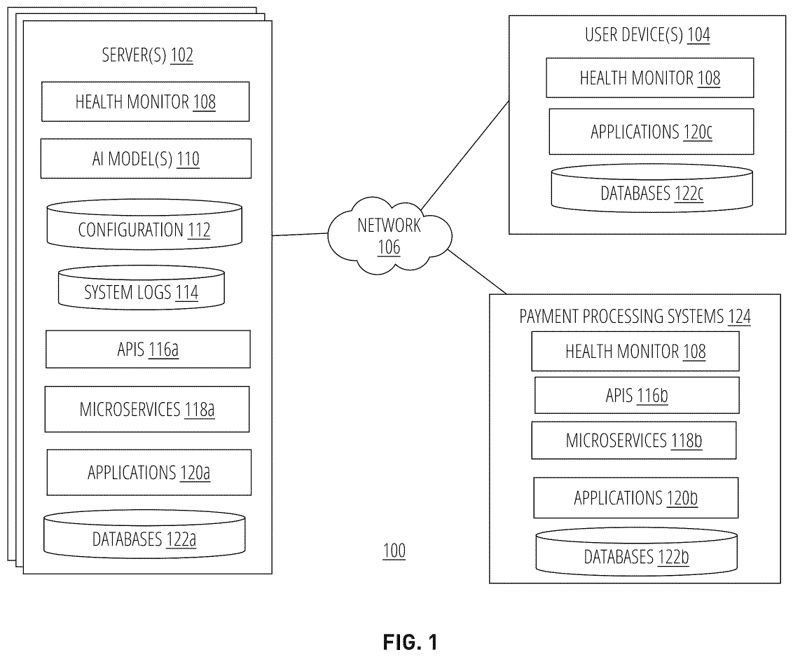

FIG. 1 illustrates a system 100 according to one embodiment. As shown, the system 100 includes one or more servers 102, one or more user devices 104, and one or more payment processing systems 124 communicably coupled via one or more networks 106. The servers 102, user devices 104, and payment processing systems 124 are representative of any type of physical and/or virtualized computing system. The servers 102, user devices 104, and payment processing systems 124 each include at least one memory for storing instructions, at least one processor for executing instructions, and at least one communications interface to communicate via the network 106, each not pictured for the sake of clarity.

As shown, the servers 102, user devices 104, and payment processing systems 124 include an instance of a health monitor 108. The health monitor 108 is generally configured to manage the health of entities in the system 100, including all software entities, hardware entities, and/or the networks 106. For example, the health monitor 108 may monitor the operation of the servers 102, user devices 104, and/or payment processing systems 124 to generate log data that may be stored in the system logs 114 of the servers 102 (and/or the user device 104 and payment processing systems 124, each not pictured for clarity). The health monitors 108 may be implemented using any type of hardware and/or software. For example, the health monitors 108 (which may include one or more of AI models 110), may be implemented via APIs, chatbots, visualizations, mobile applications, voice-response assistants, artificial intelligence assistants, microservices, etc.

The different instances of the health monitor 108 in the system 100 share information, e.g., data collected by the health monitor 108 on user device 104 and the health monitor 108 on payment processing systems 124 may be transmitted to the health monitor 108 on the servers 102, and so on.

For example, the health monitors 108 may monitor the health of a plurality of APIs 116a-116b, a plurality of microservices 118a-118b, a plurality of applications 120a-120c, and/or a plurality of databases 122a-122c, and store indications of the monitoring in the system logs 114. The applications 120a-120c represent any number and type of applications, such as such as enterprise resource planning (ERP) applications, productivity applications, games, mobile applications, video conferencing applications, audio conferencing applications, voice over internet protocol (VoIP) applications, soft phone applications, messaging applications, chatbots, email clients, web browsers, document editors, account management applications, mobile P2P payment system client applications, financial applications, payment applications, network functions, Automated Clearing House (ACH) applications, FedNow payment applications, real-time payments (RTP) applications, monetary transfer applications, mobile wallet applications, accounting applications, payment processing frameworks, etc. The databases 122a-122c represent any number and type of databases, such as account databases for customer accounts, databases for payment accounts, production databases for applications, financial institution databases, databases for cached data, and databases for files such as those for user accounts, user profiles, account balances, and transaction histories, files downloaded or received from other devices, and other data items and the like.

An API such as the APIs 116a-116b may be a set of rules and/or protocols that allows different types of software to communicate with each other. APIs generally define the methods and data formats that software can use to request and exchange information. APIs may enable the integration of different systems, facilitating the efficient sharing of data and functionality across diverse applications. Examples of types of APIs include RESTful APIs, which may use HTTP requests for operations, and are commonly used for web services, or SOAP APIs, which may use XML-based messages. Microservices are an architectural style that structures software as a collection of loosely coupled services, e.g., microservices 118a-118b. Each microservice 118a-118b may be independently deployable, developed around a specific business capability, and may be managed by different teams. Microservices 118a-118b may communicate over network 106, often using lightweight protocols like HTTP/REST or messaging queues. Microservices 118a-118b may therefore provide increased flexibility, scalability, and/or resilience. Microservices 118a-118b may allow teams to develop, deploy, and scale components independently, facilitating continuous integration and delivery. This decoupling also enables the use of different programming languages or technologies for different services, optimizing for the specific needs of each component.

Generally, an entry in the system logs 114 may include detailed information about different events, including a timestamp, an indication of a component of the system 100 associated with the event, an event type (e.g., a request, a response), and any other attribute of the event. For example, for an API call made by an application 120a to API 116b, the entry in the system logs 114 may include a timestamp of the API call, an indication of the application 120a, one or more attributes of the API call, and one or more attributes of a response received based on the API call.

More generally, the health monitors 108 may monitor actions and events in the system 100. Doing so may provide insights into performance, security, and/or usage patterns in the system 100. Examples of types of data collected by the health monitor 108 and stored in the system logs 114 include, but are not limited to resource utilization, such as processor (CPU) use, memory use, disk I/O, network activity (e.g., use of the networks 106 by the servers 102 and/or payment processing systems 124 and/or any software executing thereon), use of the databases 122a-122c, etc. Doing so may allow the health monitors 108 and/or one or more AI models 110 to identify resource bottlenecks, generate corrective actions, and initiate the corrective actions to optimize performance. The health monitors 108 may further monitor information about active processes, such as process IDs, start times, use of the databases 122a-122c, and/or CPU and memory consumption, which may be stored in the system logs 114 and used by the health monitors 108 and/or the AI models 110 to determine software execution behavior and performance. Similarly, the health monitors 108 may generate entries in the system logs 114 reflecting authentication attempts, login successes and/or failures, and access control events to help identify potential security breaches or unauthorized access. In some embodiments, the health monitors 108 collect and store, in the system logs 114, specific data for applications 120a-120c, APIs 116a-116b, and/or microservices 118a-118b, which may detail specific events, errors, or warnings. In some embodiments, the health monitors 108 collect and store, in the system logs 114, logs of system reboots, shutdowns, hardware changes, driver installations, and/or updates to track changes and stability over time. In some embodiments, the health monitors 108 collect and stores, in the system logs 114, information about errors and warnings that occur within the system 100, which may be used for troubleshooting and diagnosis purposes. In some embodiments, the health monitor 108 collects and stores, in the system logs 114, data on network connections made by entities in the system 100, including IP addresses, ports, and data transfer amounts, which may be used to detect unusual network behavior. Embodiments are not limited in these contexts, as any number and types of attributes may be stored in the entries in the system logs 114.

The configuration 112 may generally define, at least in part, the operation of the health monitor 108 and/or AI models 110. For example, the configuration 112 may include parameters and/or criteria (e.g., configurations, rules, corrective actions, and/or thresholds) used to monitor and assess the health and performance of the entities in the system 100, including the servers 102, user devices 104, payment processing systems 124, networks 106, applications 120a-120c, APIs 116a-116b, and/or microservices 118a-118b. The configuration 112 may include settings such as a list of the API 116a-116b endpoints, a list of the applications 120a-120c, a list of the microservices 118a-118b, where each list may include links (e.g., uniform resource locators (URLs)) and/or relevant metadata of each entry (e.g., the format of calls to the APIs 116a-116b and/or microservices 118a-118b, etc.).

In some embodiments, the configuration 112 may include decision trees used by the health monitors 108 and/or AI models 110 to reach an ultimate decision. In some embodiments, the decision trees may be learned and/or refined by the AI models 110. In some embodiments, the configuration 112 may be updated to add new software and/or hardware entities in the system 100, remove entries in the configuration 112, and/or modify entries in the configuration 112. The configuration 112 may further include dependencies and/or processing flows, e.g., a dependency of application 120a on API 116b, where API 116b is dependent on or otherwise calls microservice 118b, and so on. The configuration 112 may further include monitoring intervals and notification settings, which may define the frequency of health checks and the channels for alerting stakeholders. Configuration 112 may include rules and/or criteria (e.g., for each entity in the system 100), including maximum response time thresholds, error rate thresholds, resource utilization thresholds, and expected traffic patterns (including peak times and off-peak times), which may be used by the health monitor 108 and/or AI models 110 to identify performance degradation and unusual activity.

The thresholds in the configuration 112 may include, for a given entity in the system 100, thresholds for uptime and downtime, resource utilization limits, which may ensure efficient resource management and define acceptable performance levels. The configuration 112 and/or system logs 114 may be used to train the AI models 110 and facilitate learning, allowing the system 100 to generate adaptive rules and refine thresholds over time. By providing AI-driven anomaly detection via the AI models 110, embodiments disclosed herein may help identify issues before they impact users, enhancing predictive capabilities.

In some embodiments, the configuration 112 includes self-healing capabilities, such as corrective actions, rerouting traffic on the networks 106, resource scaling in the system 100, and/or fallback mechanisms, which may be initiated by the health monitors 108 and/or AI models 110 to address predicted and/or detected issues automatically.

By maintaining configuration 112, the health monitors 108 may monitor, predict, detect, and/or address performance issues in the system 100. The integration of AI, via the AI models 110, allows for continuous improvement and adaptation, ensuring the system 100 remains robust and efficient over time.

As shown, the servers 102 include the AI models 110. The AI models 110 represent any type of AI model, including, without limitation, neural networks, large language models (LLMs), or machine learning models. In some embodiments, the AI models 110 are components of the health monitor 108. In some embodiments, the health monitor 108 and/or the AI models 110 may be incorporated into an AI agent.

An AI agent is an autonomous system designed to perform tasks, make decisions, and adapt based on data and user feedback. An AI agent operates independently, automating processes in various fields, including the ability to generate code, communicate using natural language, etc. AI agents may operate without human intervention, making decisions and taking actions based on their programming and learning. AI agents may use machine learning algorithms to improve their performance over time by learning from data and experiences. Similarly, AI agents can perceive their environment through sensors or data inputs, allowing them to understand and interact with the world around them. Further still, AI agents may process information and make decisions based on logical reasoning, often using techniques like rule-based systems, neural networks, or probabilistic models. AI agents may communicate with humans and other systems through natural language processing, speech recognition, and other interfaces. AI agents may be designed to achieve specific goals or complete tasks, often optimizing their actions to maximize efficiency or effectiveness. Advantageously, AI agents may be scaled to handle large amounts of data and complex tasks, making them suitable for a wide range of applications.

In some embodiments, the AI models 110 are trained based on the configuration 112 and/or system logs 114. By analyzing this data, the AI models 110 may learn patterns and trends that indicate potential issues, allowing the AI models 110 to predict future errors and take proactive measures, e.g., initiate corrective actions. For example, one or more machine learning algorithms may be used to train the AI models 110 to identify correlations and anomalies in the training data. For example, the AI models 110 may detect that certain traffic patterns or resource utilization levels precede performance degradation or failures (e.g., of the APIs 116a-116b, applications 120a-120c, microservices 118a-118b, the servers 102, payment processing systems 124, and/or user devices 104). Similarly, the AI models 110 may be trained to classify error types into one or more of a plurality of error types. Further still, the AI models 110 may be trained to learn different decision trees and/or modify decision trees in the configuration 112.

Once trained, the AI models 110 may continuously analyze real-time data (e.g., in the system logs 114) against the established rules and thresholds in configuration 112. The AI models 110 may refine their predictions by learning from the new data, improving accuracy over time. This adaptive learning process enables the AI models 110 to anticipate issues before they occur, triggering automated corrective actions and/or alerting relevant stakeholders.

In some embodiments, the AI models 110 may include natural language chatbots that communicate using natural language. Therefore, for example, the health monitors 108 and/or AI models 110 may communicate with users and/or other instances of the health monitors 108 using natural language. For example, a user may ask “is the API 116a working properly?” In response, the health monitors 108 and/or AI models 110 may process the system logs 114 to determine whether the API 116a is functioning correctly and return a natural language response reflecting whether the API 116a is functioning correctly. In some embodiments, the APIs 116a-116b, applications 120a-120c, microservices 118a-118b, the servers 102, payment processing systems 124, and/or user devices 104 may transmit requests to the health monitors 108 for processing.

By leveraging AI models 110 trained on configuration 112 and the system logs 114, the health monitor 108 and/or AI models 110 enhance the ability to predict and prevent errors, ensuring robust performance and minimizing downtime in the system 100. This approach may improve reliability in the system 100 and may also optimize resource management and enhance overall efficiency.

Over time, as data is collected and stored in the system logs 114, the health monitors 108 and/or AI models 110 may predict and/or identify errors or other issues in the system 100. For example, in some embodiments, the health monitors 108 and/or AI models 110 may generate and execute tests against the different entities in the system 100. For example, the tests may include test API calls to the each of the plurality of APIs 116a-116b, which may be based on the lists in the configuration 112 for the APIs 116a-116b. The health monitors 108 and/or AI models 110 may execute the test API calls against the APIs 116a-116b and store indications of the test API calls in the system logs 114. Similarly, indications of responses (or the lack of any responses) to the test API calls received from the APIs 116a-116b may be stored in the system logs 114. Similarly, the tests may include tests (e.g., requests) directed to the different microservices 118a-118b, applications 120a-120c, servers 102, and/or payment processing systems 124. The health monitors 108 and/or AI models 110 may execute the tests against the microservices 118a-118b, applications 120a-120c, servers 102, and/or payment processing systems 124 store indications of the tests in the system logs 114. Similarly, indications of responses (or the lack of any responses) to the tests received from the microservices 118a-118b, applications 120a-120c, servers 102, and/or payment processing systems 124 may be stored in the system logs 114.

Based on the system logs 114, the health monitors 108 and/or AI models 110 may detect and/or predict errors in the system 100. For example, the health monitors 108 and/or AI models 110 may process the data in the system logs 114 to determine that API 116b is not responsive. As another example, the health monitors 108 and/or AI models 110 may process the data in the system logs 114 to predict that the API 116a may fail at the next payroll processing date (e.g., based on features indicating failure of the API 116a when payrolls were previously processed). In some embodiments, the health monitors 108 and/or AI models 110 may determine a type of the error (e.g., related to resource utilization, hardware, software, specific error types, etc.). In some embodiments, the error may be isolated to a specific component (e.g., one or more of the APIs 116a-116b, microservices 118a-118b, and/or applications 120a-120c) that are linked to form a processing flow. Based on detecting and/or predicting an error, the health monitors 108 and/or AI models 110 may generate and initiate a corrective action. In some embodiments, the corrective action is determined based at least in part on the configuration 112. For example, the corrective may include restarting software (e.g., the APIs 116a-116b, microservices 118a-118b, and/or applications 120a-120c), restarting the server 102 (whether physical or virtual) the API 116a executes on, deploying new instances of software (e.g., the APIs 116a-116b, microservices 118a-118b, and/or applications 120a-120c), provisioning additional computing resources to software (e.g., allocating more CPU, memory, network, and/or I/O to the APIs 116a-116b, microservices 118a-118b, and/or applications 120a-120c), rerouting traffic in the network 106, etc. Indications of the corrective actions initiated by the health monitors 108 and/or AI models 110 may be stored in the system logs 114. Doing so may allow the health monitors 108 and/or AI models 110 to determine which corrective actions corrected the errors. In some embodiments, the health monitors 108 and/or AI models 110 may follow-up with various operations and/or tests to determine if a given corrected action corrected the underlying error. In some embodiments, the health monitors 108 and/or AI models 110 may determine one or more associated users (e.g., developers, administrators, etc.) of a component experiencing an error (e.g., in the configuration 112 and/or system logs 114), and transmit an indication of the error and/or corrective action to these users as an alert. Embodiments are not limited in these contexts.

In some embodiments, the health monitors 108 and/or AI models 110 may provide multi-form and multi-directional visibility and monitoring. The multi-directional support enables any entity (e.g., the health monitors 108) to inquire about the health of another entity (e.g., another one of the health monitors 108, the APIs 116a-116b, applications 120a-120c, microservices 118a-118b, the servers 102, payment processing systems 124, and/or user devices 104). Similarly, the multi-directional support enables the health monitors 108 to respond to an inquiry received from another health monitor 108, and/or inform another health monitor 108 about the health that health monitor 108 (or another component of the system on which the health monitor 108 executes).

For example, the health monitor 108 on user device 104 may submit a natural language question “is the payment service running” to the health monitor 108 on server 102. The health monitor 108 on server 102 may provide the question as part of a prompt to the AI models 110, which may analyze the system logs 114 and generate a response. The health monitor 108 on server 102 may return the response to health monitor 108 on user device 104.

Similarly, the health monitor 108 on a first server 102 may ask the health monitor 108 on a second server 102 “is my transaction processing speed at acceptable levels?” The health monitor 108 on the second server 102 may provide the question as part of a prompt to the AI models 110, which may analyze the system logs 114 to determine whether the transaction processing speed of a specific application 120a exceeds a threshold and generate a response. The health monitor 108 on the second server 102 may return the response to health monitor 108 on the first server 102.

Further still, a user may provide input via the health monitor 108, e.g., “is the microservice 118a down?” The AI models 110 may analyze the question and the system logs 114 to determine one whether the microservice 118a is working, e.g., by generating and sending test messages and waiting for a response. The AI models 110 may then determine whether the microservice 118a is accessible based on the tests and generate a natural language response such as “no, the microservice 118a cannot be reached, but I am working on a fix. Please try again in 1 minute.”

In some embodiments, a given health monitor 108 may programmatically initiate questions and/or requests to other health monitors 108 at periodic time intervals. In some embodiments, the health monitor 108 may programmatically initiate questions and/or requests based on the system logs 114, e.g., when anomalies are predicted and/or detected.

In some embodiments, the health monitors 108 and/or AI models 110 may generate a deterministic response based on a non-deterministic and/or generic question (e.g., a natural language question). For example, the health monitor 108 may receive a request from a user such as “is the real-time service available?” However, there may be dozens or more different variables (e.g., underlying systems) involved in answering the question that the user doesn't know about. Therefore, the AI models 110 may infer, from the question and based on metadata (which may include the system logs 114, curated metadata, and/or inferred metadata), what other questions should be asked and answered in order to answer the original question.

For example, to answer the question, the health monitors 108 may poll multiple applications 120a-120c, multiple different databases 122a-122c, multiple zones of the network 106, and multiple network devices (e.g., routers, switches, etc.) in the network 106. Based on the polling, the health monitor 108 may receive data and provide the received data to the AI models 110. Based on the data, the AI models 110 may determine that one of the network zones is down. Therefore, the AI models 110 may identify, as a corrective action, whether re-routing network traffic will allow the traffic to avoid the down network segment and reach the intended destination. The AI models 110 may then determine whether re-routing the traffic according to different network reconfigurations will allow the traffic to reach its destination (e.g., without traversing the network zone that is down). The AI models 110 may then select the network reconfiguration that allows the traffic to reach its destination and reconfigure the network 106 according to the selected network configuration. As stated, in some embodiments, the AI models 110 may reach the determination to reconfigure the network based on a decision tree (e.g., in the configuration 112).

The monitoring, error detection, error prediction, and corrective actions implemented in the system 100 may be used to provide metrics such as business intelligence. Generally, the health monitors 108 may provide various graphical user interfaces (GUIs) to view insights into the health of the system 100. In some embodiments, based on the monitoring and the data in the system logs 114, the health monitors 108 and/or AI models 110 may determine business intelligence metrics, such as revenue impact and return on investment (ROI), provide insights into the financial implications of API performance, helping stakeholders make informed decisions. Embodiments are not limited in these contexts.

In some embodiments, the servers 102 and/or payment processing systems 124 may be associated with an entity, such as a financial institution, educational institution, business, etc. Similarly, a subset of the payment processing systems 124 may be associated with the entity (e.g., one or more of the servers 102 associated with the entity may be payment processing systems 124), while other subsets of the payment processing systems 124 are associated with third parties.

For example, a financial institution may maintain or otherwise be associated with the servers 102, applications 120a-120c APIs 116a-116b, microservices 118a-118b, and/or payment processing systems 124. In some embodiments, one or more servers 102 and/or payment processing systems 124 may be part of a payment processing network (not pictured). However, some of the payment processing systems 124 may associated with third parties, e.g., not managed or otherwise associated with the financial institution. Therefore, the network 106 may include a private enterprise network, while the entities in the enterprise network connect to external entities (e.g., one or more of the payment processing systems 124 and/or the user devices 104) via a public network 106 (e.g., the Internet).

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 106 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 104 may include automatic teller machines (ATMs) utilized by the system 100 in serving users. In another example, the servers 102 represent payment clearinghouse or payment rail systems for processing payment transactions, and in another example, the servers 102 such as merchant systems or banking systems configured to interact with the user devices 104 during transactions and also configured to interact with the enterprise system 100 in back-end transactions clearing processes.

The user devices 104 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 104) to serve users in their interactions to communicate and take action. In such embodiments, the user devices 104 can be, as non-limiting examples, computing devices, kiosks, terminals, smart devices such as phones, and devices and tools at customer service counters and windows at POS locations.

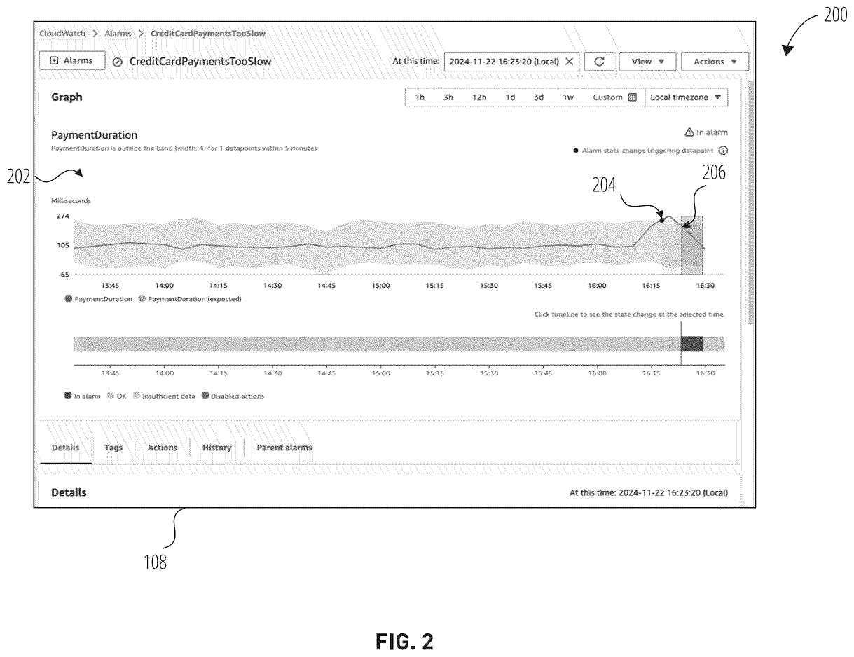

FIG. 2 illustrates an example graphical user interface 200, according to one embodiment. The graphical user interface 200 may be generated by one or more of the health monitors 108 based on the data in the system logs 114. For example, as shown, a graph 202 details the amount of time to process one or more payments, e.g., by the payment processing systems 124 and/or servers 102. For example, the payments reflected in the graph 202 may be processed via one or more of the APIs 116a-116b, microservices 118a-118b, and/or applications 120a-120c. At a point 204 on the graph 202, the amount of time to process a payment may exceed a threshold, where the threshold may be defined in the configuration 112. After point 204, the system 100 is experiencing an error because the processing time for payments exceeds a threshold. The error may be associated with one or more of the APIs 116a-116b, microservices 118a-118b, applications 120a-120c, servers 102, user devices 104, and/or payment processing systems 124. Based on the detected error, the health monitors 108 and/or AI models 110 may generate and initiate a corrective action to correct the error. As shown, at point 206, which occurs subsequent to the initiation of the corrective action, the payment processing time returns below the threshold, e.g., within the range of thresholds depicted in the graph 202. Embodiments are not limited in these contexts.

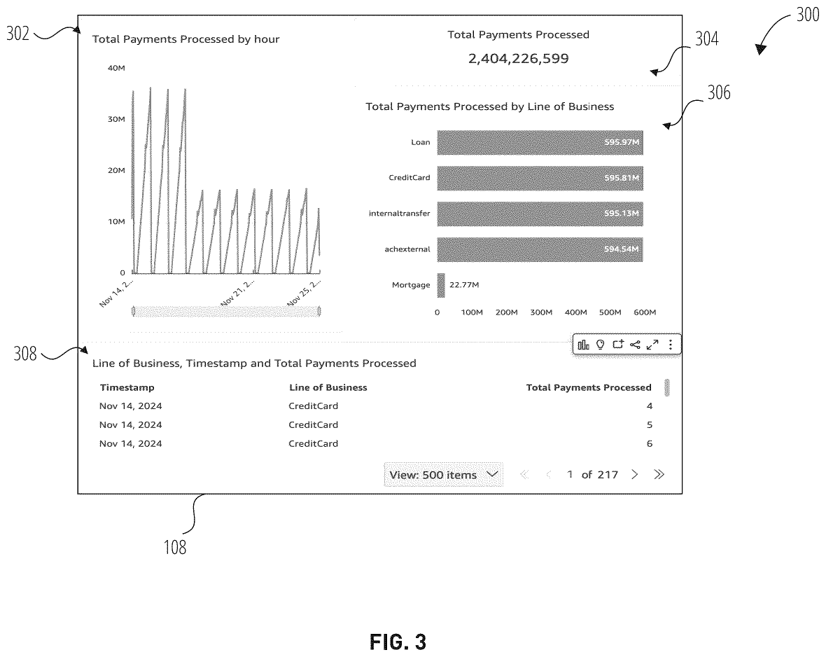

FIG. 3 illustrates a graphical user interface 300, according to one embodiment. The graphical user interface 300 may be generated by one or more of the health monitors 108 based on the data in the system logs 114. For example, as shown, a graph 302 details total payments processed per hour, e.g., by software executing on the payment processing systems 124 and/or servers 102. For example, the payments reflected in the graphical user interface 300 may be processed via one or more of the APIs 116a-116b, microservices 118a-118b, and/or applications 120a-120c. An interface element 304 depicts a total number of payments processed, while a chart 306 depicts payments processed by different lines of business, and a table 308 reflects details of specific payments. Embodiments are not limited in these contexts.

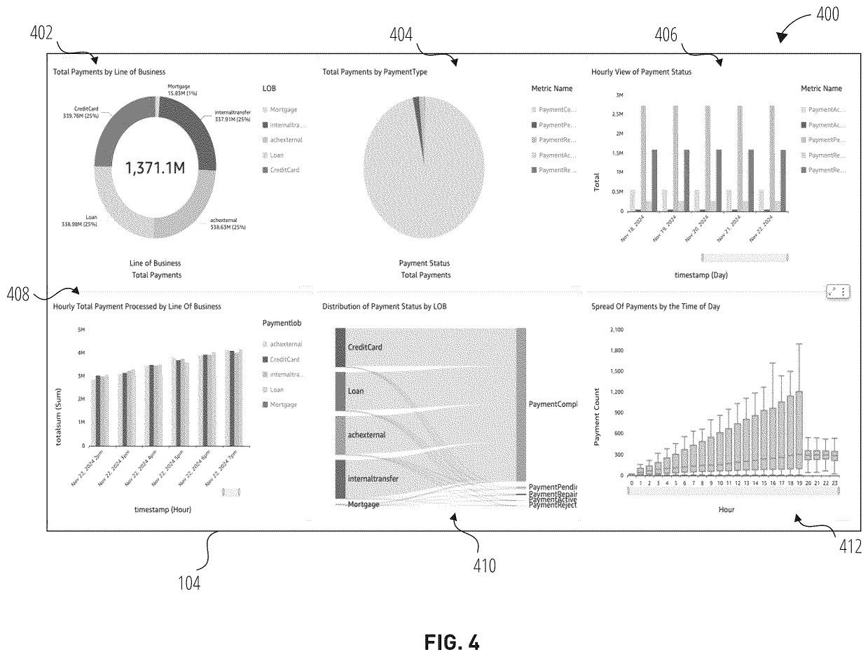

FIG. 4 illustrates a graphical user interface 400, according to one embodiment. The graphical user interface 400 may be generated by one or more of the health monitors 108 based on the data in the system logs 114. For example, as shown, chart 402 reflects a number of payments processed by the system 100 (e.g., via one or more of the APIs 116a-116b, microservices 118a-118b, and/or applications 120a-120c), where the chart 402 categorizes the processed payments based on a type and/or line of business. Similarly, type chart 404 groups the total payments processed by payment type. A performance interface 406 may display the number of payments processed per hour in a given day. Similarly, a performance interface 408 may display the number of payments processed per hour by different lines of business (and/or different payment types). A distribution interface 410 may reflect, for different payment types (and/or different lines of business), payments that had processing initiated, and corresponding result (e.g., whether the processing of the payment was completed, pending, active, rejected, repaired, etc.). A spread interface 412 may depict the number of transactions processed during each hour of the day, which may be across one or more days. Embodiments are not limited in these contexts.

The graphical user interfaces 200, 300, and 400 depict multiple GUI elements presented in combination. However, in some embodiments, the GUI elements may be presented individually in distinct GUIs. Similarly, any combination of the GUI elements may be presented in distinct GUIs. Embodiments are not limited in these contexts.

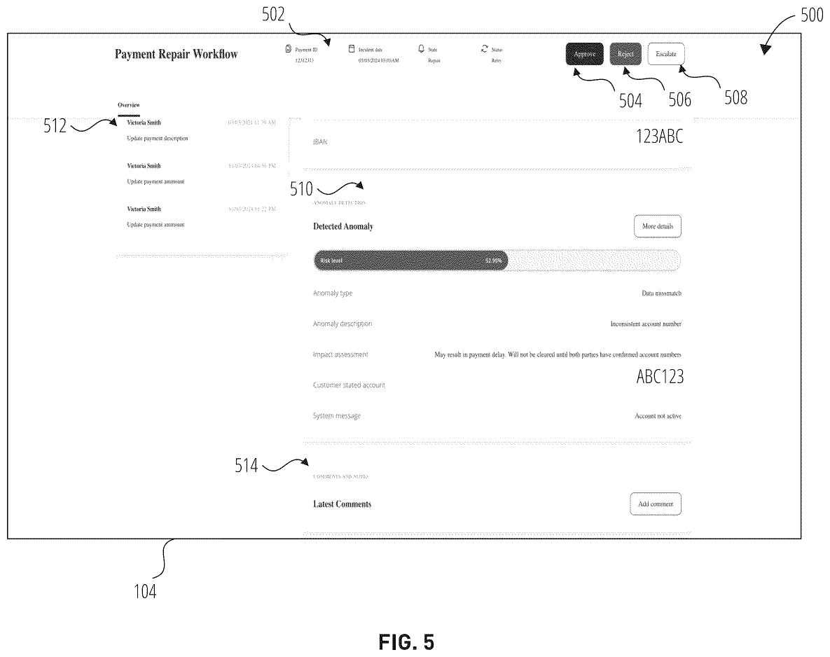

FIG. 5 illustrates a graphical user interface 500, according to one embodiment. The graphical user interface 500 may be generated by one or more of the health monitors 108 based on the data in the system logs 114. For example, the graphical user interface 500 provides information about a payment processed by the system 100 (e.g., via one or more of the APIs 116a-116b, microservices 118a-118b, and/or applications 120a-120c), where an error or anomaly was detected during processing. As show, the graphical user interface 500 includes a details section 502 with details of the transaction (e.g., a unique identifier, a timestamp, a processing status, and a state). Using an approve element 504, a reject element 506, or an escalation element 508, a user may approve processing, reject processing, or escalate processing of the transaction, respectively. The anomaly information section 510 provides information related to one or more anomalies associated with processing the payment. A history section 512 displays different events associated with the transaction. Using the comment interface 514, a user may enter additional comments that may appear in the history section 512 when submitted.

In some embodiments, the health monitors 108 and/or AI models 110 may process the data associated with graphical user interface 500 in the system logs 114, which may include other records of other transactions that were not processed. In such embodiments, the health monitors 108 and/or AI models 110 may detect an error in the system 100, e.g., an error associated with one or more of the APIs 116a-116b, microservices 118a-118b, applications 120a-120c, servers 102, user devices 104, and/or payment processing systems 124. Based on the error, the health monitors 108 and/or AI models 110 may generate a corrective action to repair the error and initiate performance of the corrective action to correct the error. Embodiments are not limited in these contexts.

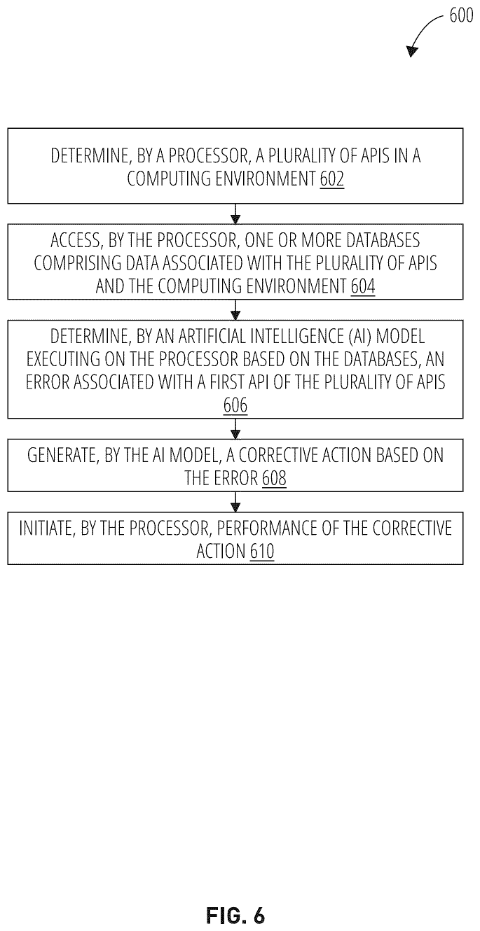

FIG. 6 illustrates an example logic flow 600 for using artificial intelligence to detect and/or predict errors and generate corrective actions. Although the example logic flow 600 depicts a particular sequence of operations, the sequence may be altered without departing from the scope of the present disclosure. For example, some of the operations depicted may be performed in parallel or in a different sequence that does not materially affect the function of the logic flow 600. In other examples, different components of an example device or system that implements the logic flow 600 may perform functions at substantially the same time or in a specific sequence.

According to some examples, the logic flow 600 includes determining, by a processor, a plurality of APIs in a computing environment at block 602. For example, the health monitor 108 executing on server 102 may determine, based on the configuration 112, a plurality of APIs 116a-116b in system 100. In some embodiments, block 602 is initiated responsive to a request received by the health monitor 108, such as a natural language request. In some embodiments, block 602 is initiated by the health monitor 108 at predetermined time intervals.

According to some examples, the logic flow 600 includes accessing, by the processor, one or more databases comprising data associated with the plurality of APIs and the computing environment at block 604. For example, the health monitor 108 and/or AI models 110 executing on server 102 may access the system logs 114 which include data associated with the plurality of APIs and the computing environment (e.g., the APIs 116a-116b, microservices 118a-118b, applications 120a-120c, servers 102, user devices 104, and/or payment processing systems 124).

According to some examples, the logic flow 600 includes determining, by an artificial intelligence (AI) model executing on the processor based on the databases, an error associated with a first API of the plurality of APIs at block 606. For example, one or more of the AI models 110 may determine, based on the system logs 114, an error associated with a first API of the plurality of APIs, e.g., API 116b. In some embodiments, the error is actively occurring. In some embodiments, the error is not occurring and is a predicted error.

According to some examples, the logic flow 600 includes generating, by the AI model, a corrective action based on the error at block 608. For example, the AI model 110 may generate a corrective action based on the error. Examples of corrective actions include restarting hardware and/or software, re-routing traffic, resource scaling, resource provisioning, transmitting notifications, etc.

According to some examples, the logic flow 600 includes initiating, by the processor, performance of the corrective action at block 610. For example, the health monitors 108 and/or AI models 110 may initiate performance of the corrective action in the system, e.g., restarting hardware and/or software, re-routing traffic, resource scaling, resource provisioning, transmitting notifications, etc. Embodiments are not limited in these contexts.

As used herein, an artificial intelligence system, artificial intelligence agent, artificial intelligence algorithm, artificial intelligence module, program, and the like, generally refer to computer implemented programs that are suitable to simulate intelligent behavior (e.g., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

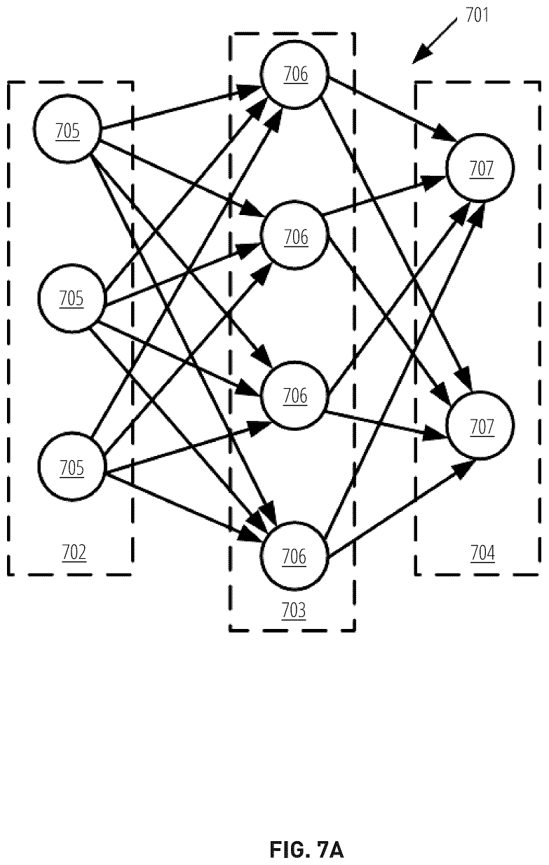

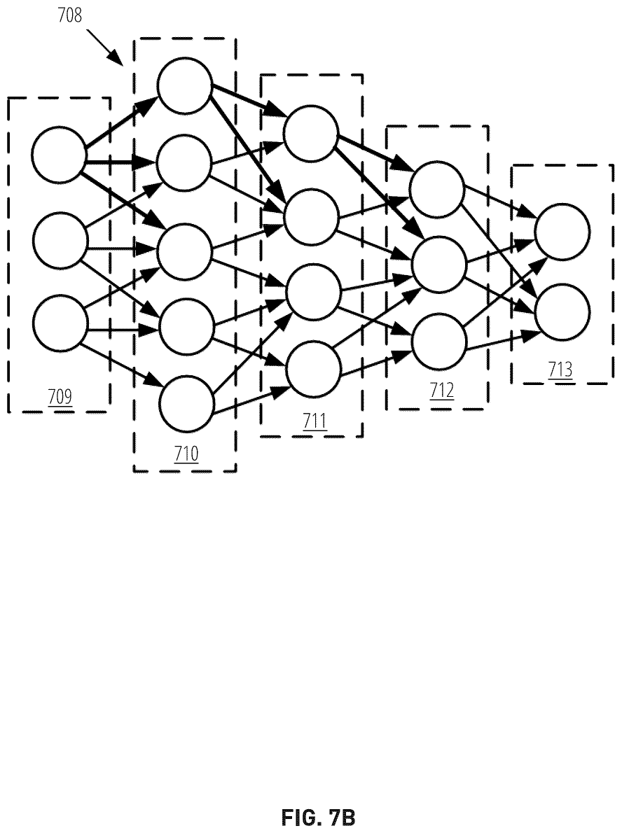

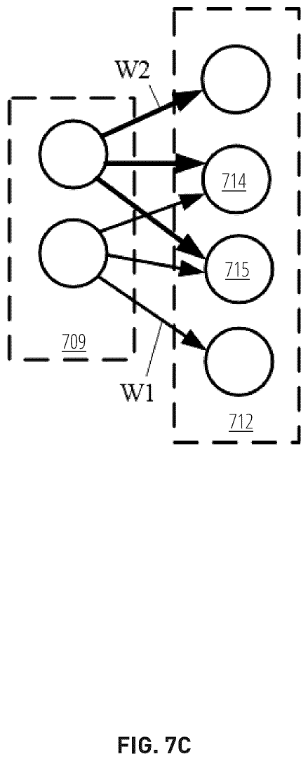

An artificial neural network (ANN), also known as a feedforward network, may be utilized, e.g., an acyclic graph with nodes arranged in layers. A feedforward network (see, e.g., feedforward network 701 referenced in FIG. 7A) may be included in the AI models 110 and include a topography with a hidden layer 703 between an input layer 702 and an output layer 704. The input layer 702, having nodes commonly referenced in FIG. 7A as input nodes 705 for convenience, communicates input data, variables, matrices, or the like to the hidden layer 703, having nodes 706. The hidden layer 703 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 705 of the input layer, which then communicates the data to the hidden layer 703. The hidden layer 703 may be configured to determine the state of the nodes in the respective layers and assign weight coefficients or parameters of the nodes based on the edges separating each of the layers, e.g., an activation function implemented between the input data communicated from the input layer 702 and the output data communicated to the nodes 707 of the output layer 704. It should be appreciated that the form of the output from the neural network may generally depend on the type of model represented by the algorithm. Although the feedforward network 701 of FIG. 7A expressly includes a single hidden layer 703, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). The AI models 110 may include one or more CNNs such as convolutional neural network 708. A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 708 in FIG. 7B. As in the feedforward network 701 of FIG. 7A, the illustrated example of FIG. 7B has an input layer 709 and an output layer 713. However where a single hidden layer 703 is represented in FIG. 7A, multiple consecutive hidden layers 710, 711, and 712 are represented in FIG. 7B. The edge neurons represented by white-filled arrows highlight that hidden layer nodes can be connected locally, such that not all nodes of succeeding layers are connected by neurons.

FIG. 7C, representing a portion of the convolutional neural network 708 of FIG. 7B, specifically portions of the input layer 709 and the first hidden layer 710, illustrates that connections can be weighted. In the illustrated example, labels W1 and W2 refer to respective assigned weights for the referenced connections. Two hidden nodes 714 and 715 share the same set of weights W1 and W2 when connecting to two local patches.

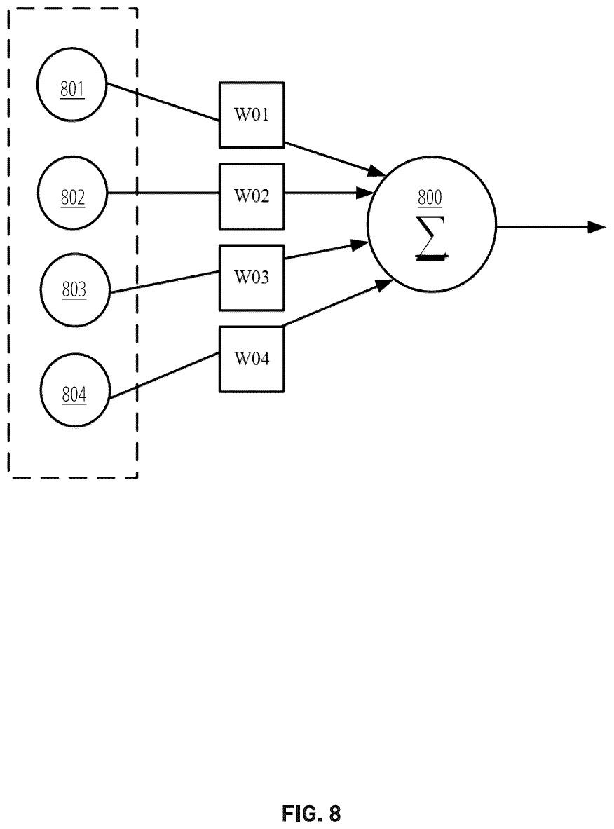

Weight defines the impact a node in any given layer has on computations by a connected node in the next layer. FIG. 8 represents a particular node 800 in a hidden layer. The node 800 is connected to several nodes in the previous layer representing inputs to the node 800. The input nodes 801, 802, 803 and 804 are each assigned a respective weight W01, W02, W03, and W04 in the computation at the node 800, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current computation of the parameter, e.g., at least a portion of the output data from the RNN may be used as feedback/input in computing subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

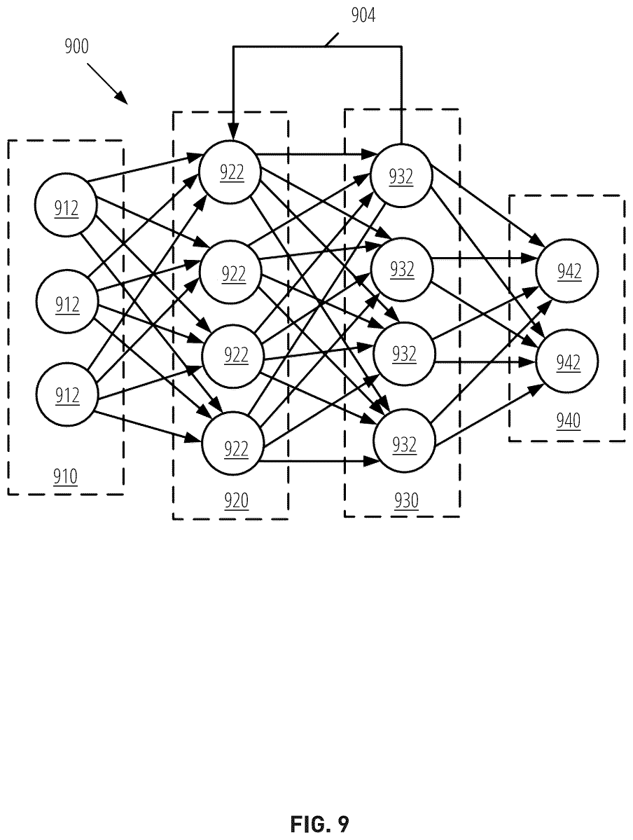

An example for a Recurrent Neural Network (RNN) is referenced as 900 in FIG. 9. The AI models 110 may include one or more of the RNNs 900. As in the feedforward network 701 of FIG. 7A, the illustrated example of FIG. 9 has an input layer 910 (with nodes 912) and an output layer 940 (with nodes 942). However, where a single hidden layer 703 is represented in FIG. 7A, multiple consecutive hidden layers 920 and 930 are represented in FIG. 9 (with nodes 922 and nodes 932, respectively). As shown, the RNN 900 includes a feedback connector 904 configured to communicate parameter data from at least one node 932 from the second hidden layer 930 to at least one node 922 of the first hidden layer 920. It should be appreciated that two or more and up to all of the nodes of a subsequent layer may provide or communicate a parameter or other data to a previous layer of the RNN 900. Moreover and in some embodiments, the RNN 900 may include multiple feedback connectors 904 (e.g., connectors 904 suitable to communicatively couple pairs of nodes and/or feedback connectors 904 configured to provide communication between three or more nodes). Additionally or alternatively, the feedback connector 904 may communicatively couple two or more nodes having at least one hidden layer between them, e.g., nodes of nonsequential layers of the RNN 900.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

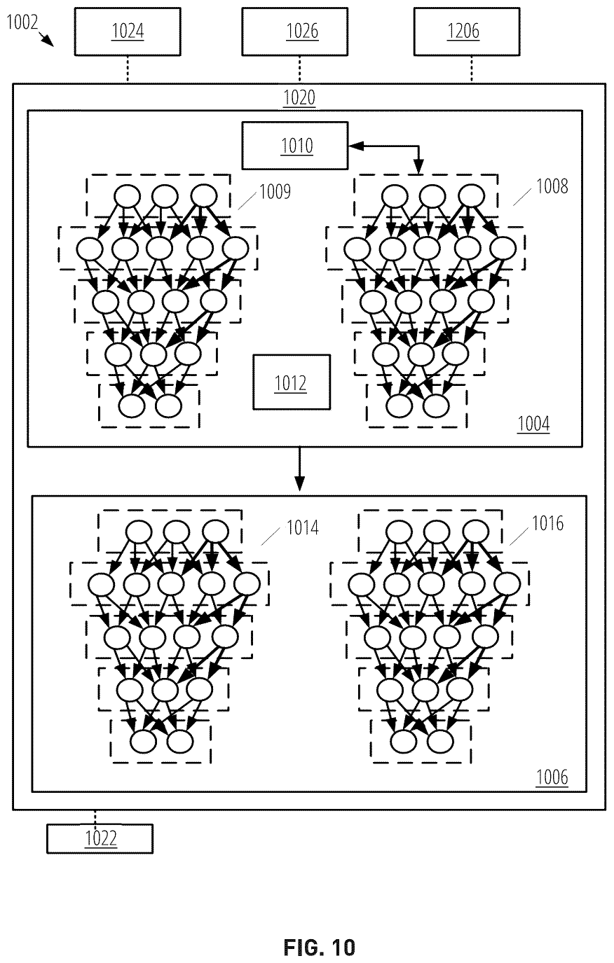

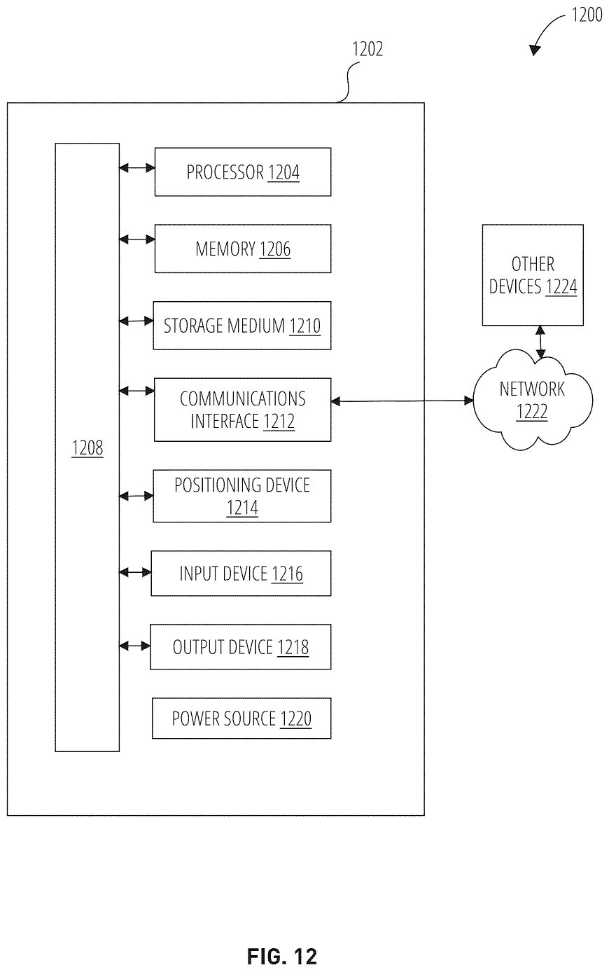

Referring now to FIG. 10 and some embodiments, an artificial intelligence (AI) program 1002 may include a front-end algorithm 1004 and a back-end algorithm 1006. The artificial intelligence program 1002 may be implemented on an AI processor 1020, such as the processor 1204 of computer 1202 of FIG. 12, and/or a dedicated processing device (e.g., servers 102 and/or user devices 104). In some embodiments, the AI models 110 include one or more of the artificial intelligence programs 1002. The instructions associated with the front-end algorithm 1004 and the back-end algorithm 1006 may be stored in an associated memory device and/or storage device of the system (e.g., memory 1024 and/or storage 1026 in FIG. 10), etc.) communicatively coupled to the AI processor 1020, as shown. Additionally or alternatively, one or more memory devices and/or storage devices (e.g., storage medium 1210 and/or memory 1206 of FIG. 12, etc.) may be used for processing use and/or including one or more instructions necessary for operation of the AI program 1002. In some embodiments, the AI program 1002 may include a deep neural network (e.g., a front-end algorithm 1004 configured to perform pre-processing, such as feature recognition, and a back-end algorithm 1006 configured to perform an operation on the data set communicated directly or indirectly to the back-end algorithm 1006). For instance, the front-end algorithm 1004 can include at least one CNN 1008 communicatively coupled to send output data to the back-end algorithm 1006.

Additionally or alternatively, the front-end algorithm 1004 can include one or more AI algorithms 1010, 1012 (e.g., statistical models or machine learning programs such as decision tree learning, associate rule learning, recurrent artificial neural networks, support vector machines, and the like). In various embodiments, the front-end algorithm 1004 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 1008 and/or AI algorithm 1010 may be used for image recognition, input categorization, and/or support vector training. In some embodiments and within the front-end algorithm 1004, an output from an AI algorithm 1010 may be communicated to a CNN 1008 or 1009, which processes the data before communicating an output from the CNN 1008, 1009 and/or the front-end algorithm 1004 to the back-end algorithm 1006. In various embodiments, the back-end algorithm 1006 may be configured to implement input and/or model classification, speech recognition, translation, and the like. For instance, the back-end algorithm 1006 may include one or more CNNs (e.g., CNN 1014) or dense networks (e.g., dense networks 1016), as described herein.

For instance, and in some embodiments of the AI program 1002, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end algorithm 1004). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 1002 may be trained using a semi-supervised learning process in which some but not all of the output data is known, e.g., a mix of labeled and unlabeled data having the same distribution.

In some embodiments, the AI program 1002 may be accelerated via a machine learning framework 1022 (e.g., hardware). The machine learning framework may include an index of operations, subroutines, and the like (primitives) typically implemented by AI and/or machine learning algorithms. Thus, the AI program 1002 may be configured to utilize the primitives of the framework 1022 to perform some or all of the computations required by the AI program 1002. Primitives suitable for inclusion in the machine learning framework 1022 include operations associated with training a convolutional neural network (e.g., pools), tensor convolutions, activation functions, algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

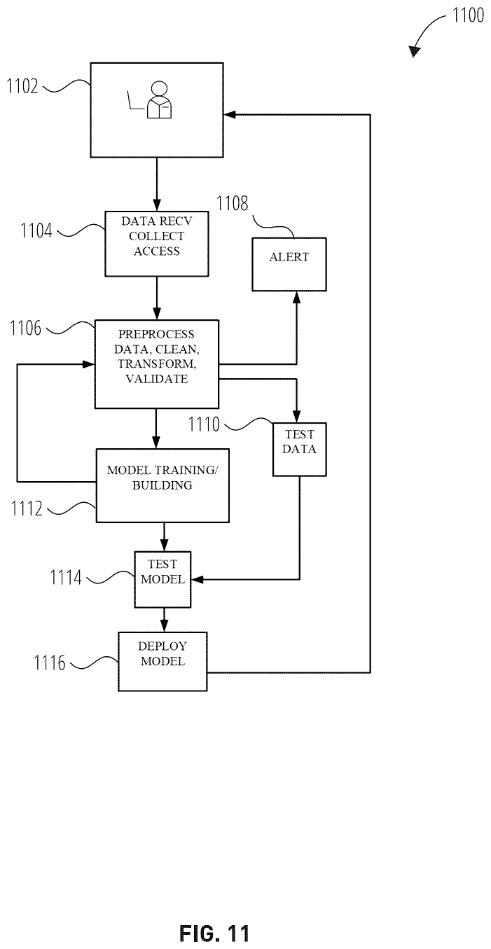

FIG. 11 is a flow chart representing a logic flow 1100, according to at least one embodiment, of model development and deployment by machine learning. The logic flow 1100 represents at least one example of a machine learning workflow in which operations are implemented in a machine-learning project, e.g., for one or more of the AI models 110.

In block 1102, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 1102 can represent a starting point. However, with regard to continuing or improving an ongoing machine learning workflow, block 1102 can represent an opportunity for further user input or oversight via a feedback loop. Such feedback may flow through a user, or in various embodiments, the method automatically provides feedback, retrains and redeploys the retrained model.

In block 1104, data is received, collected, accessed, or otherwise acquired and entered as can be termed data ingestion. In block 1106, the data ingested in block 1104 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 1106 is updated with newly ingested data, an updated model will be generated. Block 1106 can include data validation, which focuses on confirming that the statistics of the ingested data are as expected, such as that data values are within expected numerical ranges, that data sets are within any expected or required categories, and that data comply with any needed distributions such as within those categories. Block 1106 can proceed to block 1108 to automatically alert the initiating user, other human or virtual agents, and/or other systems, if any anomalies are detected in the data, thereby pausing or terminating the process flow until corrective action is taken.

In block 1110, training test data such as a target variable value is inserted into an iterative training and testing loop. In block 1112, model training, a core step of the machine learning workflow, is implemented. A model architecture is trained in the iterative training and testing loop. For example, features in the training test data are used to train the model based on weights and iterative computations in which the target variable may be incorrectly predicted in an early iteration as determined by comparison in block 1114, where the model is tested. Subsequent iterations of the model training, in block 1112, may be conducted with updated weights in the computations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (e.g., the model is underfitted), the system may automatically determine that the threshold level of accuracy is not satisfied and may adjust the weights for a subsequent iteration of the training and testing loop. The weights may be iteratively adjusted during each iteration of the training and testing loop based on the comparison to the threshold level of accuracy. However, there is a balance for training the model to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained. In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using computed derivatives to minimize a loss function. Backpropagation may be used to compute the gradient of the error function with respect to the neural network's weights.

When compliance and/or success in the model testing in block 1114 is achieved, process flow proceeds to block 1116, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see block 1116) and the feedback loop automatically provides feedback for further training of the machine learning model to improve its performance, and upon completion of the other method blocks such as block 1112, the machine learning model that has been automatically retrained based on the feedback loop is then redeployed (block 1114). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions for detecting anomalies to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security as reflected in the system logs 114. For example, the system 100 (e.g., the health monitors 108 and/or AI models 110) may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

The systems and methods disclosed herein may also be used to analyze text (e.g., in the system logs 114) to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply robotic process automation for digital transformation of the data based on specific criteria to interpret text and unstructured data using text processing software techniques. The interpretation of the text may be implemented using the AI models 110 described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (e.g., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a computed probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corporate of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—e.g., ascertain or derive a new classification or subject, and not just classification into an existing subject or classification. Unsupervised learning software systems are also used for association rules mining to discover relationships between features from content data.

The content driver software service utilizes one or more supervised or unsupervised software processing techniques to perform a subject classification analysis to generate subject data. Suitable software processing techniques can include, without limitation, Latent Semantic Analysis, Probabilistic Latent Semantic Analysis, Latent Dirichlet Allocation. Latent Semantic Analysis software processing techniques generally process a corpus of alphanumeric text files, or documents, to ascertain statistical co-occurrences of words that appear together, which then give insights into the subjects of those words and documents. The content driver software service can utilize software processing techniques that include Non-Matrix Factorization, Correlated Topic Model (“CTM”), and K-Means or other types of clustering.

Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels, interrogatory labels, content source labels, or sentiment labels, thereby generating annotated training set content data. For example, a person can utilize a labeling software application to review training set content data to identify and tag or “annotate” various parts of speech, subjects, interrogatories, content sources, and sentiments.

The training set content data may then be fed to the content driver software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the computed probability and the known certainty. Then parameters to the neural network are adjusted (e.g., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic interaction between a provider agent and a user and designate such empty files as not suitable for use in a subject classification analysis. As another example, the qualification analysis can designate files below a certain size or having a shared experience duration below a given threshold (e.g., less than one minute) as also being unsuitable for use in the subject classification analysis.

The reduction analysis can also perform a contradiction operation to remove contradictions and punctuations from the content data. Contradictions and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contradictions can be replaced according to a standard library of known abbreviations, such as replacing the acronym “brb” with the phrase “be right back.” The contradiction operation can also remove or replace contractions, such as replacing “we're” with “we are.”

The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (e.g., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifiers in the content data (e.g., topics or subjects addressed in the content data) or interaction driver identifiers in the content data (e.g., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency-inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (e.g., topics) addressed within the content data. The subject classification analysis can specifically identify one or more interaction driver identifiers that are the reason why a user initiated a shared experience or support service request. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (e.g., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recomputed, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (e.g., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifiers.

The software model may be evaluated according to three categories, including a “good match” where the support request reason(s) are identified by the top words in the subject vector (e.g., the words with the highest weight or frequency), a “moderate” match where the support request reason(s) are identified by the second tier of words in the subject vector (e.g., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identifier, which is taken as subject weighting data. A similar analysis can be performed on vectors created through other processing, such as K-means clustering or techniques that generate vectors where each word in the vector is replaced with a probability that the word represents a subject identifier or request driver data.

To illustrate generating subject weighting data, for any given subject there may be numerous subject vectors. Assume that for most of subject vectors, the dot product will be close to zero—even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifiers may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are computed for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The content driver software service can also use term frequency-inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the content driver software service.

The content data can be visualized and subject to a reduction into two-dimensional data using a UMAP to generate a cluster graph visualizing a plurality of clusters. The content driver software service feeds the two-dimensional data into a DBSCAN and identify a center of each cluster of the plurality of clusters. The process may, using the two dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The content driver software service can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (e.g., a content source).

The systems and methods disclosed herein may utilize deployed models (e.g., AI models 110) to make predictions about future errors in a computing system such as system 100 or computing system 1200. The use of specially trained models realizes a number of improvements over traditional methods of error prediction, including more accurate error prediction and corrective action generation. Further, the systems and methods disclosed herein lead to faster training times and a more accurate model.

The systems and methods disclosed herein reflect an improvement in the functioning of a computer or an improvement to other technology or a technical field by improving the accuracy of errors predicted by the AI models 110 and improving the accuracy of corrective actions generated by the AI models 110 (e.g., the corrective actions may prevent predicted errors from occurring and/or correct detected errors).

In addition, the systems and methods utilize a particular machine or manufacture such as, for example, servers 102, user devices 104, and/or payment processing systems 124. The servers 102, user devices 104, and/or payment processing systems 124 are integral to effectuating the improvements disclosed herein by collecting and storing data describing the system 100 in the system logs 114. Further, the systems and methods disclosed herein utilize a combination of software and hardware that include, for example, a physical circuit, which is a machine or manufacture.

FIG. 12 illustrates an example computing system 1200 suitable for implementing various embodiments as described herein. As shown, the computing system 1200 comprises a computer 1202, which is representative of any type of physical and/or virtualized computing device. Examples of the computer 1202 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1202 is representative of some or all of the components of the servers 102, user devices 104, and/or payment processing systems 124. More generally, the computing system 1200 is configured to implement all systems, methods, apparatuses, media, and embodiments disclosed herein.

As shown, the computer 1202 includes one or more processors 1204, one or more memories 1206, one or more non-transitory storage media 1210, one or more communications interfaces 1212, one or more positioning devices 1214, one or more input devices 1216, and one or more output devices 1218 communicably coupled via an interconnect 1208. A power source 1220, such as a power supply, battery, or any type of power source may provide power to the computer 1202.

The processor 1204 is representative of any type of processing circuit. For example, the processor 1204 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1206 is representative of any computer readable medium to store data, code, or other information. The memory 1206 may include volatile memory, such as volatile Random Access Memory (RAM) including a cache area for the temporary storage of data. The memory 1206 may also include non-volatile memory, which can be embedded and/or may be removable. The non-volatile memory can additionally or alternatively include an electrically erasable programmable read-only memory (EEPROM), flash memory or the like. The storage medium 1210 is representative of any type of computer readable medium to store data, code, or other information. Examples of storage media 1210 include solid state drives, hard drives, Redundant Array of Independent Disks (RAID) drives, memory pools, universal serial bus (USB) storage devices, and the like.

The memory 1206 and storage medium 1210 can store any number and type of computer-executable instructions executed by the processor 1204 to implement the functions of the computer 1202 described herein. For example, the memory 1206 may include the health monitor 108, AI models 110, APIs 116a-116b, microservices 118a-118b, applications 120a-120c, etc. The applications 120a-120c may include as a web browser application and/or a mobile P2P payment system client application. These applications also typically provide a graphical user interface (GUI) on a display that allows the user to communicate with the computer 1202, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1206 and/or storage medium 1210 may be used to store data such as cached data, files for user accounts, user profiles, account balances, transaction histories, files downloaded or received from other devices, and any other data items.

The interconnect 1208 is representative of any type of circuitry to connect the components of the computer 1202. For example, the interconnect 1208 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1204 to the memory 1206, individual electrical connections among the components, and electrical conductive traces on a motherboard common to some or all of the above-described components of the computer 1202. As discussed herein, the interconnect 1208 may operatively couple various components with one another, or in other words, electrically connects those components, either directly or indirectly—by way of intermediate component(s)—with one another.

The one or more input devices 1216 are representative of any type of input device for receiving input, such as a keypad, keyboard, touchscreen, touchpad, microphone, camera, fingerprint sensor, mouse, joystick, other pointer device, button, soft key, and the like. The one or more output devices 1218 are representative of any type of device for outputting information, such as a monitor, speaker, haptic feedback module, printer, and the like.

The computer 1202 may use the communications interface 1212 to communicate with one or more other devices 1224 via a network 1222. The communications interface 1212 allows the computer 1202 to communicate with and conduct transactions with other devices and systems, such as the other devices 1224. The communications interface 1212 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, General Packet Radio Service (GPRS), fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, are all non-limiting and non-exclusive examples. Thus, communications can be conducted, for example, via the wireless communications interface 1212, which can be or include a radio-frequency transceiver, a Bluetooth device, Wi-Fi device, a Near-Field Communication (NFC) device, and other wireless transceivers. In addition, a positioning device 1214 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (e.g., 802.11a, b, g, n, ac, ax, be, bn, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 1212, e.g., using USB, Ethernet, and other physically connected modes of data transfer. The network 1222 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1202 is configured to use the communications interface 1212 as, for example, a network interface to communicate with one or more other devices on a network such as network 1222. In this regard, the computer 1202 utilizes the wireless communications interface 1212 as an antenna operatively coupled to a transmitter and a receiver (together a “transceiver”) included with the communications interface 1212. The communications interface 1212 is configured to provide signals to and receive signals from the transmitter and receiver, respectively. The signals may include signaling information in accordance with the air interface standard of the applicable cellular system of a wireless telephone network. In this regard, the computer 1202 may be configured to operate with one or more air interface standards, communication protocols, modulation types, and access types. By way of illustration, the computer 1202 may be configured to operate in accordance with any of a number of first, second, third, fourth, fifth-generation communication protocols and/or the like. For example, as a smartphone, the computer 1202 may be configured to operate in accordance with second-generation (2G) wireless communication protocols such as TDMA, GSM, and/or IS-95 (e.g., CDMA), with third-generation (3G) wireless communication protocols, such as Universal Mobile Telecommunications System (UMTS), CDMA2000, WCDMA and/or time division-synchronous CDMA (TD-SCDMA), with 4G wireless communication protocols such LTE, 5G wireless communication protocols, BLE communication protocols such as Bluetooth 5.0, UWB communication protocols, and/or the like. The computer 1202 may also be configured to operate in accordance with non-cellular communication mechanisms, such as via a wireless local area network (WLAN) or other communication/data networks.

The communications interface 1212 may also include a payment network interface. The payment network interface may include software, such as encryption software, and hardware, such as a modem, for communicating information to and/or from one or more devices on a network. For example, the computer 1202 may be configured so that it can be used as a credit or debit card by, for example, wirelessly communicating account numbers or other authentication information to a terminal of the network. Such communication could be performed via transmission over a wireless communication protocol such as the NFC protocol.

The computer 1202 may be under the control of any suitable operating system (not pictured). Example operating systems include, but are not limited to, Linux® operating systems, UNIX®, Windows® operating systems, macOS®, iOS®, Android® and any other type of operating system.

The computer 1202 as illustrated diagrammatically represents at least one example of a possible implementation, where alternatives, additions, and modifications are possible for performing some or all of the described methods, operations, and functions. Although shown separately, in some embodiments, two or more computers 1202, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
determining, by a processor, a plurality of application programming interfaces (APIs) in a computing environment;
accessing, by the processor, one or more databases comprising data associated with the plurality of APIs and the computing environment;
determining, by an artificial intelligence (AI) model executing on the processor based on the databases, an error associated with a first API of the plurality of APIs;
generating, by the AI model, a corrective action based on the error; and
initiating, by the processor, performance of the corrective action.

2. The method of claim 1, further comprising prior to determining the error:
generating, by the processor, a plurality of test API calls; and
executing, by the processor, the plurality of test API calls.

3. The method of claim 2, wherein each test API call is directed to one or more of the plurality of APIs.

4. The method of claim 3, wherein the error is determined based on at least one of the plurality of test API calls.

5. The method of claim 4, wherein the plurality of test API calls test the plurality of APIs.

6. The method of claim 1, wherein the corrective action comprises one or more of: (i) provisioning computing resources in the computing environment, (ii) deploying another instance of the first API in the computing environment, or (iii) re-routing network traffic in the computing environment.

7. The method of claim 1, wherein the data in the one or more databases is generated based on monitoring the computing environment.

8. The method of claim 7, further comprising subsequent to determining the error:
receiving, by the processor, additional data based on the monitoring; and
generating, by the AI model based at least in part on the additional data, a predicted error.

9. The method of claim 8, wherein the predicted error is associated with a second API of the plurality of APIs.

10. The method of claim 9, further comprising:
transmitting, by the processor, an indication of the predicted error via a network.

11. The method of claim 7, wherein one or more entries in the one or more databases comprises: a respective timestamp of the entry, one or more attributes of a request associated with the respective entry, and one or more attributes of a response associated with the respective entry.

12. The method of claim 1, further comprising:
determining, by the processor, an error associated with a second API of the plurality of APIs; and
determining by the processor, the error associated with the first API is a cause of the error associated with the second API.

13. The method of claim 12, further comprising:
determining, by the processor, that a processing flow includes the first API and the second API.

14. The method of claim 1, wherein determining the error comprises:
determining, by the AI model, a type of the error one is of a plurality of types of errors.

15. The method of claim 1, wherein the one or more databases comprise data associated with a plurality of microservices and a plurality of applications in the computing environment.

16. The method of claim 1, wherein the one or more databases comprise data associated with a plurality of networks in the computing environment.

17. The method of claim 1, further comprising:
generating, by the processor, a graphical user interface comprising indications of a subset of the data associated with the APIs; and
outputting, by the processor, the graphical user interface on a display.

18. The method of claim 1, wherein the error is further determined based at least in part on one or more rules.

19. A non-transitory computer-readable storage medium, the computer-readable storage medium including instructions that when executed by a processor, cause the processor to:
determine a plurality of application programming interfaces (APIs) in a computing environment;
access one or more databases comprising data associated with the plurality of APIs and the computing environment;
determine, by an artificial intelligence (AI) model based on the databases, an error associated with a first API of the plurality of APIs;
generate, by the AI model, a corrective action based on the error; and
initiate performance of the corrective action.

20. An apparatus, comprising:
a processor; and
a memory storing instructions that, when executed by the processor, cause the processor to:
determine a plurality of application programming interfaces (APIs) in a computing environment;
access one or more databases comprising data associated with the plurality of APIs and the computing environment;
determine, by an artificial intelligence (AI) model based on the databases, an error associated with a first API of the plurality of APIs;
generate, by the AI model, a corrective action based on the error; and
initiate performance of the corrective action.
